(19) United States
(12) Patent Application Publication
(10) Pub. No.: US 2014/0244728 A1
(43) Pub. Date: Aug. 28, 2014

(54) CONTROLLER, METHOD FOR CONTROLLING, AND COMPUTER-READABLE RECORDING MEDIUM HAVING STORED THEREIN CONTROL PROGRAM

(71) Applicant: Fujitsu Limited, Kawasaki-shi (JP)

(72) Inventors: Tomotaka ENDO, Yokohama (JP); Masahiko OHASHI, Nagoya (JP); Kinji KAWAGUCHI, Yokohama (JP); Koji IWAMOTO, Yokohama (JP)

(73) Assignee: Fujitsu Limited, Kawasaki-shi (JP)

(21) Appl. No.: 14/158,094

(22) Filed: Jan. 17, 2014

(30) Foreign Application Priority Data
Feb. 25, 2013 (JP) 2013-034477

(51) Int. Cl. H04L 29/06

(52) U.S. Cl. CPC H04L 67/42
USPC 709/203

(57) ABSTRACT

A controller is disposed between a terminal device and one or more processing devices that carry out processing in response to a request from the terminal device. The controller controls the processing devices and includes a processor that: when a destination processing device that is to respond to the request from the terminal device among the processing devices is in a stop state, carries out startup control to change status of the destination processing device from the stop state to an operating state, and causes a proxy responding unit that responds to the terminal device on behalf of the one or more destination processing devices to respond to the terminal device; and after the status of the destination processing device is changed to the operating state, transmits the request from the terminal device to the destination processing device.

### CROSS-REFERENCE TO RELATED APPLICATION

This application is based upon and claims the benefit of priority of the prior Japanese Patent Application No. 2013-034477, filed on Feb. 25, 2013, the entire contents of which are incorporated herein by reference.

### FIELD

The embodiment discussed herein is a controller, a method of controlling, and a computer-readable recording medium having stored therein a control program.

### BACKGROUND

There have been known various systems in which servers provide service to a user terminal via a network. In such systems, a user terminal issues a request for a service to server and the server carries out processing according to the request and transmits response containing the result of processing to the user terminal.

The server carries out service (application) that is to be provided to the user terminal on a virtual server or on an Operating System (OS) (i.e., a physical server). For example, when the Central Processing Unit (CPU) is not loaded much, the server may save the consumption of electric power by changing the status of one or more virtual servers or OSs (physical servers) being in the operating state into the stop state (e.g., shut-down state or sleep state).

From the aspect of the continuity of using the system, it is preferable that the server always receive requests from the user terminal. However, when the CPU is highly loaded and is in the busy state, the server has sometimes difficulty in accepting requests from the user terminal.

For example, accesses of connection requests from user terminals to the server seems to concentrate on the service receiving attendance and application for business expenses in particular term such as a couple of hours on Mondays (or the first business day in every week), closing day, and the end of account term. Except the above term, since accesses to the server are small in number, the server provides service using a virtual server having smaller scale than the maximum configuration or changes the status of the OS (i.e., physical server) into the stop state by saving the consumption of electric power.

If a server using a small number of virtual servers receives a large number of requests during the above particular term, the small number of operating virtual servers accumulates processes to be carried out in response to the request to make the servers themselves into the busy state and consequently it may be difficult to transmit a response to the received connection requests to user terminals. Although receiving many requests in the above particular term, a server that has made the OS thereof into the stop state is incapable of transmitting a response to the received connection requests to user terminals. In any of these cases, the user terminal that has transmitted the connection request would repeat retransmission (retries) of the connection request until the user terminal receives a response from the server and the connection between the user terminal and the server is successfully established.

In one of related known technique, a management server manages the start or the end of using spare machines, considering loaded status of multiple computers dealing with requests (e.g., see Patent Literature 1). The management server in this technique determines the number of spare machines to be startup by referring to data that associates a threshold of an amount of load with the number of spare machines that are to carry out processing to distribute the load.
[Patent Literature 1] Japanese Laid-open Patent Publication No. 2005-11331

In the above system, under a state where many users are receiving service, if a user terminal issuing connection request for service but not being allowed to smoothly establish the connection repeats transmission of the request, accesses to the server (network) further concentrates.

In a server providing service using a small number of virtual servers, concentration of accesses on the server worsens the busy state, so that it comes more difficult for users to receive the service.

In a server having OS that has made OS thereof into the stop state, concentration of accesses on the server may result in delay in startup process of the server because connection requests received therein interfere the startup process, so that it takes a longer time to change the status of the server into an operating state, which allows the server to response to the connection requests. Also in this case, users are not allowed to smoothly receive the service.

Furthermore, in a server carrying out power saving control, concentration of accesses on the network may generate congestion in the network to make users difficult to receive service provided from another server.

When a server (processing device) temporarily has a difficulty in responding to a request from a user terminal (terminal devices) in the above system, retransmission of the request from the user terminal further declines the performance of the entire system.

Unfortunately, the related technique detailed the above does not consider the problems.

### SUMMARY

According to an aspect of the embodiment, a controller disposed between a terminal device and one or more processing devices that carry out processing in response to a request from the terminal device, the controller controlling the processing devices and including: a processor that: when a destination processing device that is to respond to the request from the terminal device among the processing devices is in a stop state, carries out startup control to change status of the destination processing device from the stop state to an operating state, and causes a proxy responding unit that responds to the terminal device on behalf of the one or more destination processing devices to respond to the terminal device; and after the status of the destination processing device is changed to the operating state, transmits the request from the terminal device to the destination processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the configuration of an information processing system according to a first embodiment;

FIG. 2 is a diagram illustrating an example of the hardware configuration of a service environment control server of FIG. 1;

FIG. 3 is a diagram illustrating an example of the configuration of a service environment control server of FIG. 1;

FIG. 4 is a diagram illustrating an example of the data structure of a server status data DB that a service environment control server of FIG. 1 retains;

FIG. 5 is a diagram illustrating an example of the data structure of a control condition defining data DB that a service environment server of FIG. 1 retains;

FIG. 6 is a diagram illustrating an example of the data structure of a control data DB that a service environment server of FIG. 1 retains;

FIG. 7 is a diagram illustrating an example of the data structure of a session data DB that a service environment server of FIG. 1 retains;

FIG. 8 is a diagram illustrating an example of the data structure of a proxy responding data DB that a service environment server of FIG. 1 retains;

FIG. 9 is a flow diagram illustrating an example of a succession of procedural steps of a service environment control server according to the first embodiment;

FIG. 10 is a sequence diagram illustrating an example of a succession of procedural steps of operation performed by a service environment control server according to the first embodiment;

FIG. 11 is a flow diagram illustrating an example of a succession of procedural steps of operation performed by a service environment control server according to the first embodiment;

FIG. 12 is a sequence diagram illustrating an example of a succession of procedural steps of operation performed by a service environment control server according to the first embodiment;

FIG. 13 is a flow diagram illustrating an example of a succession of procedural steps of operation performed by a service environment control server according to the first embodiment;

FIG. 14 is a flow diagram illustrating an example of a succession of procedural steps of operation performed by a service environment control server according to the first embodiment;

FIG. 15 is a sequence diagram illustrating an example of a succession of procedural steps of operation performed by a service environment control server according to the first embodiment;

FIG. 16 is a sequence diagram illustrating an example of a succession of procedural steps of operation performed by a service environment control server according to the first embodiment; and

FIG. 17 is a sequence diagram illustrating an example of a succession of procedural steps of operation performed by a service environment control server according to the first embodiment.

### DESCRIPTION OF EMBODIMENTS

Hereinafter, an embodiment will now be described with reference to the accompanying drawings.

(1) first embodiment:

(1-1) information processing system:

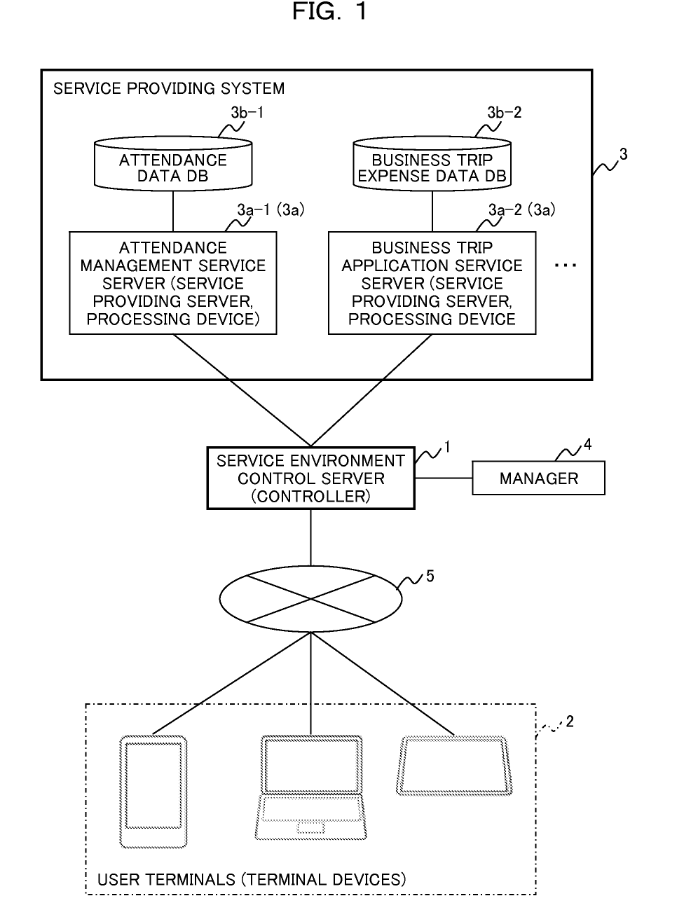

FIG. 1 is a diagram illustrating an information processing system according to the first embodiment. As illustrated in FIG. 1, the information processing system of the first embodiment includes a service environment control server 1, a user terminal 2, a service providing system 3, and a manager 4.

A user terminal (terminal device) 2 is connected to a network 5, issues a request to the service providing system 3, and carries out processing according to a response from the service providing system 3. In order to carry out such processing, the user terminal 2 includes at least a processor such as a CPU, a memory, and an interface that achieves wired or wireless communication with the network 5. These hardware elements in the user terminal 2 do not appear in the drawings. Examples of the user terminal 2 include various information processing device such as a smartphone, a PC, or a tablet computer. The network 5 can be any network such as Internet or an intranet.

The service providing system 3 is a system that provides the user terminal 2 with predetermined service. As illustrated in FIG. 1, the service providing system 3 includes, for example, an attendance management service server 3a-1, a business trip application service server 3a-2, an attendance data Database (DB) 3b-1, and a business trip expense data DB 3b-2. In addition to the above, the service providing system 3 further includes a hardware resource of an information processing unit, which does not appear in the drawings.

The attendance management service server 3a-1 and the business trip application service server 3a-2 are virtual servers or physical servers (serving as service providing servers) that provide the user terminal with predetermined service and are examples of a processing device that respond to requests from the user terminal 2.

The information processing unit included in the service providing system 3 includes at least a processor such as a CPU, a memory, a non-volatile memory such as a Hard Disk Drive (HDD), and an interface that achieves wired or wireless communication with the service environment control server 1. These hardware elements included in the information processing unit of the service providing system 3 do not appear in the drawings. Using the hardware elements, the information processing unit achieves the functions of the attendance management service server 3a-1 and the business trip application service server 3a-2 serving as virtual or physical servers.

The attendance management service server 3a-1 is a server that carries out predetermined processes in response to various requests for registering, updating, and referring to attendance data from a user and the attendance data DB 3b-1 is a database that retains the attendance data of each user. For example, the attendance management service server 3a-1 registers, updates or reads the attendance data of each user retained in the attendance data DB 3b-1 in response to a request from the user terminal 2, and transmits the result of the processing to the user terminal 2.

The business trip application service server 3a-2 is a server that carries out predetermined processes in response to various requests for registering, updating, and referring to business trip expense data related to a business trip or the expense of a business trip from a user, and the business trip expense data DB 3b-2 is a database that retains the business trip expense data of each user. For example, the business trip application service server 3a-2 registers, updates, or reads the business trip expense data of each user retained in the business trip expense data DB 3b-2 in response to a request from a user and transmits the result of the processing to the user terminal 2.

Hereinafter, when the attendance management service server 3a-1 and the business trip application service server 3a-2 are not discriminated from each other, these servers are simply referred to as service providing servers 3a or servers 3a.

The service providing system 3 assumes to have two servers 3a in the example illustrated in FIG. 1, but the number of servers 3a is not limited to two. Alternatively, the service providing system 3 may includes one or more servers 3a.

The manager 4 is a device that manages the service environment control server 1. For example, the person in charge of management of the service environment control server 1 or the service providing system 3 sets control condition defining data that is to be described below in the service environment control server 1 through operating the manager 4.

The manager 4 includes a processor such as a CPU, a memory, an interface that achieves wired or wireless communication with the service environment control server 1, and Input/Output (I/O) unit. These hardware elements included in the manager 4 do not appear in the drawings. The I/O unit satisfactorily includes at least one of an input device such as a mouse and a keyboard and an output device such as a display and a printer. For example, the CPU of the manager 4 receives control condition defining data input from the person in charge of management through the I/O unit (I/O device) and transmits the received data to the service environment control server 1 through the interface. The CPU of the manager 4 displays (outputs) the result of the processing received from the service environment control server 1 on the output device.

In the example of FIG. 1, the manager 4 is connected to the service environment control server 1 and alternatively may be connected to the service environment control server 1 via the network 5. If the person in charge of management inputs the control condition defining data into the service environment control server 1 using an I/O unit 10e that is to be detailed below and that is included in the service environment control server 1 and refers to the result of the processing displayed (output) on the I/O unit 10e, the manager 4 may be omitted.

The service environment control server (controller) 1 is an information processing unit that is disposed between the user terminal 2 and the service providing servers 3a and that controls the servers 3a.

(1-2) Hardware Configuration of Service Environment Control Server:

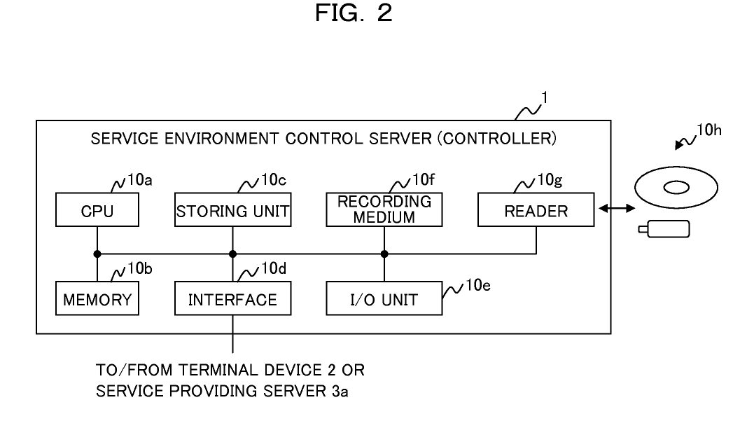

Next, description will now be made in relation to the hardware configuration of the service environment control server 1 with reference to FIG. 2, which is a diagram illustrating an example of the configuration of the service environment control server 1 of FIG. 1.

As illustrated in FIG. 2, the service environment control server 1 includes a CPU 10a, a memory 10b, a storing unit 10c, an interface 10d, the I/O unit 10e, a recording medium 10f, and a reader 10g.

The CPU 10a is connected to the memory 10b, the storing unit 10c, the interface 10d, the I/O unit 10e, the recording medium 10f, and the reader 10g, and is a processor that carries out various controls and calculations. The CPU 10a achieves various functions of the service environment control server 1 by carrying out program stored in, for example, the memory 10b, the storing unit 10c, the recording medium 10f, the recording medium 10h via the reader 10g, or a non-illustrated Read Only Memory (ROM). Alternatively, the processor serving as the CPU 10a may be replaced with an electronic circuit such as a Micro Processing Unit (MPU).

The memory 10b is a memory device that temporarily stores therein various pieces of data and programs, and temporarily stores and expands therein data and a program when the CUP 10a is executing the program. An example of the memory 10b is a volatile memory such as a Random Access Memory (RAM).

The storing unit 10c is a device exemplified by a magnetic disk such as a HDD, a semiconductor drive device such as a Solid State Drive (SSD), or non-volatile memory such as a flash memory, and is a hardware device that stores therein various pieces of data and programs.

The interface 10d is a controller that controls connection and communication between the service providing system 3 and the network 5 with or without wire.

The I/O unit 10e satisfactorily includes at least one of an input device such as a mouse and a keyboard and an output device such as a display and a printer. For example, the I/O unit 10e is used by the person in charge of management when he/she inputs the control condition defining data and refers to the result of processing performed by the service environment control server 1.

The recording medium 10f is a memory device such as a flash memory and a ROM, and stores therein various pieces of data and programs. The reader 10g reads data and programs stored in the recording medium 10h that is computer-readable recording medium such as an optical disk or a Universal Serial Bus (USB) memory.

At least one of the recording media 10f and 10h may store therein a control program that achieves the functions of the service environment control server 1 of the first embodiment. This means that the CPU 10a achieves the functions of the service environment control server 1 by expanding the control program input from the recording medium 10f or from the recording medium 10h via the reader 10g in the memory 10b and executing the expanded program.

The above hardware devices are communicably connected to each other via a bus.

Connection between two entities in the information processing system, that is, the connection between the user terminal 2 and the network 5, between the service environment control server 1 and the network 5, between the service environment control server 1 and the service providing system 3 may be wired or wireless. Examples of a cable for wired connection include a Local Area Network (LAN) cable, an InfiniBand (registered trademark), Fibre Channel, and a serial cable such as a USB cable. The cable may be a parallel cable. Example of wireless communication may be wireless LAN, Bluetooth®, and wire less USB. The connection among the information processing system is not limited to the above examples and may be established by any manner.

The above hardware configuration of the service environment control server 1 is an example. Accordingly, the service environment control server 1 may include additional hardware elements or may omit the above hardware elements, or may divide the above hardware elements appropriately. Furthermore, an information processing unit including the hardware elements illustrated in FIG. 2 may be provided for each function of the service environment control server 1. The functions of the service environment control server 1 will be described below.

(1-3) Service Environment Control Server:

Next, the service environment control server 1 will now be detailed.

As described above, the service environment control server 1 carries out control of the service providing server 3a. For example, the service environment control server 1 relays requests and responses transmitted and received between the terminal device 2 and the service providing servers 3a. The service environment control server 1 monitors packets of a request issued from the terminal device 2 and controls the status of the server 3a on the basis of the result of the monitoring.

Specifically, the service environment control server 1 carries out the following controls (1) through (3).

(1) On the basis of the status of using the service providing servers 3a by the user terminal 2, the service environment control server 1 changes the status of the service providing server 3a satisfying a predetermined condition from the operating state to the stop state.

(2) On the basis of the above using status, the service environment control server 1 determines the service providing server 3a (hereinafter refers to the destination server 3a) that is the destination of a request from the user terminal 2 and also determines the server status (sometimes simply refers to status) of the destination server 3a. Specifically, if the destination server 3a is in the operating state, the service environment control server 1 transmits (relays) the request to the destination server 3a.

(3) If the destination server 3a is in the stop state, the service environment control server 1 carries out the following controls (3-1) and (3-2).

(3-1) The service environment control server 1 changes the status of the destinations server 3a from the stop state to the operating state and also replies to the user terminal 2 that has transmitted the request with a notification that the destination server 3a is in a state of changing to the operating state on behalf of the destination server 3a.

(3-2) When the destination server 3a has changed to the operating state, the service environment control server 1 transmits (relays) the request to the destination server 3a.

The operating state means that the service providing server 3a is in a state of capable of transmitting a response to a request from the user terminal 2.

The stop state means that the service providing server 3a is in a state of having a difficulty in responding to a request from the user terminal 2. Specifically, the stop state includes at least one of the shut-down state in which power supply to the server 3a is stopped and asleep state in which power supply to some of the hardware elements in the server 3a is stopped.

As the above, the service environment control server 1 changes the status of the service providing server 3a to the stop state by carrying out the control (1) according to the status of using the service providing servers 3a by the user terminal 2, so that the consumption power of the service providing server 3a can be saved.

In addition, the service environment control server 1 transfers a request from the user terminal 2 to the destination server by carrying out the control (2) in the same manner as cases where the service environment control server 1 is absent.

Furthermore, the service environment control server 1 notifies the user terminal 2 that the destination server 3a is in a state of changing to the operating state on behalf of the destination server 3a by carrying out the control (3) until the service providing server 3a has changed from the stop state to the operating state, so that the user terminal 2, which has received the notification, can avoid repeatedly transmitting (retrying) the same request. Thereby, the service environment control server 1 can abate concentration on accesses to the destination server 3a (network 5). Accordingly, the service environment control server 1 can reduce the processing load on the destination server 3a and thereby rapidly resolves a situation where the destination server has a difficulty in providing service to users. Furthermore, the service environment control server 1 lessens the congestion of the network so that the users can escape from having a difficulty in using the other service providing server 3a. The control (3) by the service environment control server 1 can suppress reduction in performance of the entire system.

(1-4) Example of the Configuration of the Service Environment Control Server:

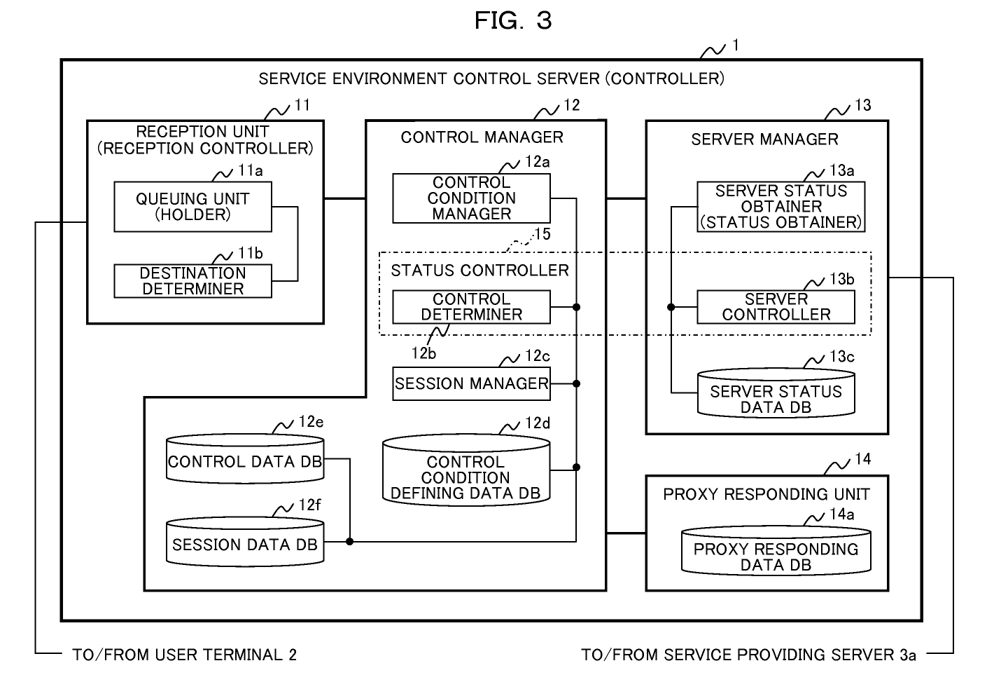

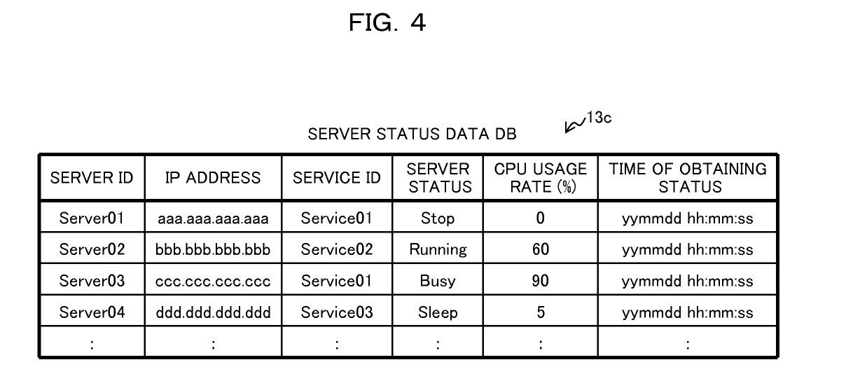

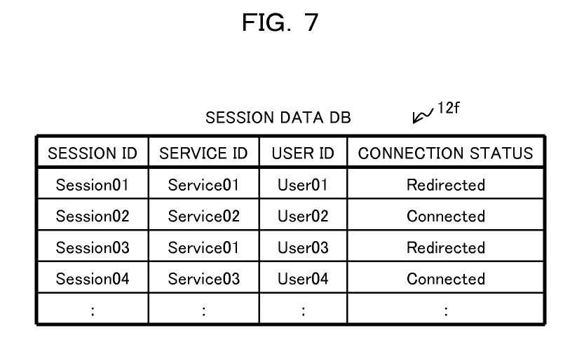

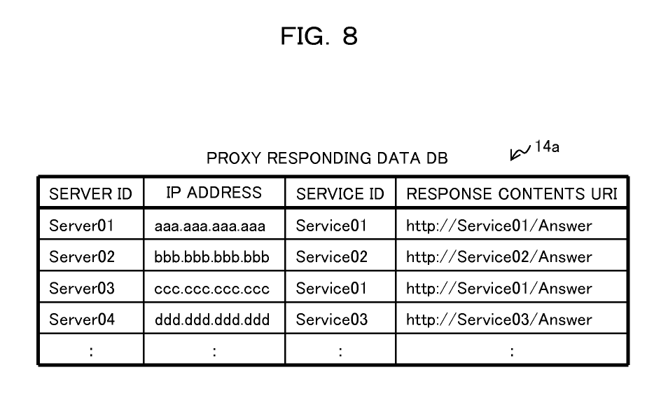

Hereinafter, description will now be made in relation to an example of the configuration of the service environment control server 1 with reference to FIGS. 3-8. FIG. 3 is a diagram illustrating an example of the configuration of the service environment control server 1; FIGS. 4-6 are diagrams illustrating examples of the data structures of a server status data DB 13c, a control condition defining data DB 12d, a control data DB 12e that the service environment control server 1 retains, respectively; FIGS. 7 and 8 are diagrams illustrating examples of the data structure of a session data DB 12f and a proxy responding data DB 14a that the service environment control server 1 retains, respectively.

As illustrated in FIG. 3, the service environment control server 1 includes a reception unit 11, a control manager 12, a server manager 13, and a proxy responding unit 14.

(1-4-1) Server Manager:

The server manager 13 transmits and receives information including data and commands to and from the service providing servers 3a. Specifically, the server manager 13 obtains the server status (sometimes simply called status) from each service providing servers 3a. The server manager 13 further controls the status of the service providing servers 3a.

For example, the server manager 13 includes a server status obtainer 13a, a server controller 13b, and the server status data DB 13c.

The server status obtainer (status obtainer) 13a obtains the server status from the service providing server 3a. For example, upon receipt of a request for obtaining the server status from the control manager 12 that is to be detailed below, the server status obtainer 13a issues a request to obtain the server status to the service providing server 3a and determines (obtains) the server status using the result of responses from the service providing server 3a. The request to obtain the server status is periodically issued from the control manager 12. Each time the server manager 13 receives a periodic request for obtaining the server status from the control manager 12, the server manager 13 obtains the server status.

In response to the request to obtain the server status from the control manager 12, the server status obtainer 13a may obtain the server status of all the service providing servers 3a connected to the service environment control server 1 or may be one or more particular service providing servers 3a specified by the request.

Upon obtaining the server status from the server(s) 3a, the server status obtainer 13a updates the server status data DB 13c of FIG. 4.

The server status data DB 13c is a database that manages the server status of each service providing server 3a, and stores therein server status data of the data structure (status data) illustrated in FIG. 4 for each server 3a. As illustrated in FIG. 4, the server status data includes a server ID, an Internet Protocol (IP) address, a service ID respectively representing examples of identification data of the server 3a, the address of the server 3a, and identification data of the service that the server 3a provides. In addition, the server status data includes server status that the server status obtainer 13a obtains from the server 3a, a CPU usage rate (%) of the server 3a, the time of obtaining the server status (status obtaining time). The server status data DB 13c of FIG. 4 includes the server status of five servers having IDs “Server01” through “Server04”. As an example, the server ID “Server01” is associated with the IP address “aaa.aaa.aaa.aaa”, a service ID “Service01”, a server status “Stop”, a CPU usage rate (%) “0”, and the time of obtaining the status “yymmdd hh:mm:ss”.

For example, the server status obtainer 13 a preferably obtains data except for the sever status, the CPU usage rate, and the time of obtaining status that are to beset in the server status data DB 13c in advance, and sets the obtained data in the server status data DB 13c. In addition to the server status and the CPU usage rate, the server status obtainer 13a may obtain data except for the time of obtaining the status that is to be set in the server status data DB 13c and may set the obtained data in the server status data DB 13c.

The server status obtainer 13a preferably obtains the CPU usage rate using a predetermined command for monitoring the working status of the server 3a independently of responding to the request to obtain the server status for the reason to be detailed below. The CPU usage rate can be obtained by any known method, which is not detailed here.

Upon obtaining the server status and the CPU usage rate, the server status obtainer 13a sets the obtained server status, the obtained CPU usage rate, the time when the server status is obtained in a corresponding record in the server status data DB 13c.

As illustrated in FIG. 4, examples of the server status are “Running”, “Stop”, “Sleep”, and “Busy” respectively representing the operating state, the shut-down state of the stop state, the sleep state of the stop state, and the busy state.

The items included in the server status data DB 13c should by no means be limited to those illustrated in FIG. 4. For example, server status data DB 13c may hold additional data pieces obtainable from the server 3a, such as the network usage rate of the server 3a.

In this example, the IP address is used as the address of the server 3a but is not limited to. Alternatively, the address of the server 3a may be any address that can specify the virtual or physical server serving as the server 3a.

Here, description will now be made in relation to a manner in which the server status obtainer 13a determines the server status.

After issuing a request for obtaining the server status to the server 3a, the server status obtainer 13a determines whether the service providing server 3a responses to the request within a predetermined time period. If the service providing server 3a responds to the request within the time period, the server status obtainer 13a determines that the service providing server 3a is in the operating state.

On the other hand, if the service providing server 3a does not respond to the request within the time period, there is a high possibility that the service providing server 3a is in the shut-down state, the sleep state, or the busy state. Then, the server status obtainer 13a further determines, using a predetermined command to monitor the hardware status of the server 3a, whether the hardware devices of the server 3a is being supplied with electric power. This determination can be made in any known manner, which is not detailed here. If the hardware of the service providing server 3a is not being supplied with electric power, the server status obtainer 13a determines that the service providing server 3a is in the shut-down state.

If the hardware of the service providing server 3a is being supplied with electric power, there is a high possibility that the server 3a is in the sleep state or the busy state. This is because, when the server 3a is in the sleep state, the hardware (at least the CPU and the memory) of the server 3a is supplied with electric power while, when the server 3a is in the busy state, the server 3a is working and electric power is supplied to the hardware of the server 3a. On the basis of the above, the server status obtainer 13a refers to the CPU usage rate obtained by the server 3a and determines whether the CPU usage rate is a threshold or less. Even if the server 3a does not respond to the request for obtaining the server status, the server status obtainer 13a can obtain the CPU usage rate by using a predetermined command to obtain the CUP usage rate independently of the request.

If the CPU usage rate is the threshold or less, the server status obtainer 13a determines that the server 3a is in the sleep state because the server 3a being in the sleep state mainly uses the CPU thereof to refresh the memory, so that the server 3a is kept to be low loaded.

On the contrary, if the CPU usage rate is higher than the threshold, the server status obtainer 13a determines that the server 3a is in the busy state because the server 3a being in the busy state is loaded as high as the server 3a is not afford to respond to the request for obtaining the server status.

The server status obtainer 13a determines the server status in the above manner.

After updating the server status data DB 13c, the server status obtainer 13a reads the server status and the server ID or the IP address that specifies the server 3a from the server status data DB 13c in response to the request from the control manager 12. Then, the server status obtainer 13a outputs the read data, as the obtaining response of the server status, to the control manager 12. An obtaining response of the server status may include the server status and the server IDs or the IP addresses of all the records of the records of the server status data DB 13c or those of a record that has been changed in the latest update. Alternatively, the server status obtainer 13a may output the entire server status data DB 13c, as the obtaining response, to the control manager 12.

The obtaining response of the server status is used by the control manager 12 to determine whether the server 3a is to be changed to the operating state to the stop state.

Furthermore, when receiving a request for inquiry about the server status from the control manager 12, the server status obtainer 13a reads the server status corresponding to the inquiry from the server status data DB 13c and outputs the read server status, as the inquiry response of the server status, to the control manager 12. The inquiry response of the server status is used by the reception unit 11 that is to be detailed below to determine whether the server 3a is in the operating state when the above control (2) or (3) is to be carried out.

Hereinafter, description will now be made in relation to the processing performed when the server status obtainer 13a receives an inquiry about the server status from the control manager 12.

The inquiry about the server status includes the IP address of the server 3a, the address being assigned by the reception unit 11.

Upon receipt of the inquiry request, the server status obtainer 13a refers to the server status data DB 13c and recognizes the service ID of the service provided by the server 3a having the assigned IP address. The server status obtainer 13a determines whether the server status data DB 13c stores therein a record of an additional server 3a that has a service ID the same as the recognized service ID. If the server status data DB 13c stores therein a record of an additional server 3a having the same service ID, the server status obtainer 13a outputs the server status of all the servers 3a having the recognized service ID and the server IDs or the IP addresses that specify these servers 3a, as an inquiry response about the server status, to the control manager 12.

Here, servers 3a having the same service ID in the server status data DB 13c (in the example of FIG. 4, servers having the server IDs “Server01” and “Server03”) are capable of providing the same service to the user terminal 2.

When another server 3a (i.e., IP address) can provide the same as the service provided by the server 3a having the assigned IP address, the server status obtainer 13a includes, in the inquiry response, the server status of the other server 3a in addition to the server status of the server 3a corresponding to the assigned address in the inquiry request. This makes the reception unit 11 possible to avoid carrying out unnecessary startup control on the server 3a corresponding to the inquiry request being in the stop state although another server 3a that is capable of providing the same service as the assigned sever 3a and that is in the operating state is present.

The server controller 13b controls the service providing server 3a in response to a control request from the control manager 12.

Specifically, upon receipt of a control request to change the status of a server 3a from the operating state to the stop state from the control manager 12, the server controller 13b issues a control request to change the status of the server 3a assigned in the control request into the stop state such as the shut-down state or the sleep state to the server 3a. In contrast, upon receipt of a control request to change the status of a server 3a from the stop state to the operating state from the control manager 12, the server controller 13b issues a control request to change the status of the server 3a assigned in the control request from the stop state to the startup state to the server 3a.

Upon receipt of a control response from the server 3a that has undergone status control according to a control request, the server controller 13b sets the server status after the change and the time of updating the server status (time of obtaining the status) in the corresponding record of the server in the server status data DB 13c.

After the server 3a changes the status thereof from the stop state to the operating state, the server 3a outputs control response containing a notification that the startup of the server 3a is completed to the server controller 13b.

On the other hand, when the server 3a changes the status thereof from the operating state to the stop state, the server 3a outputs the control response containing the planned start time (or seconds left before the changing) of changing into the stop state such as the shut-down state or the sleep state to the server controller 13b. After receiving this control response, the server controller 13b may wait until the planned start time, then update the server status data DB 13c, and transmit the inquiry response to the control manager 12. In addition, the server controller 13b may instruct the server status obtainer 13a to obtain the server status of the server 3a after the planned start time to confirm whether the stopping of the server 3a is completed.

Upon receipt of a request from the user terminal 2 through the reception unit 11, the server manager 13 forwards the request to the destination address of the request when the server 3a identified by the destination address is in the operating state.

Even when the server 3a identified by the destination address of the request from the user terminal 2 is in the stop state or the busy state but when a server having the same service ID as that of the server 3a identified by the destination address and being in the operating state is present, the server manager 13 may forward the request to the server being in the operating state.

The manner of specifying a server 3a having the same service ID of the server 3a identified by the destination address of the request is the same as that performed by the server status obtainer 13a, and repetitious description is omitted here.

As described above, the server manager 13 can specify the server 3a being the destination of the request from the user terminal 2 among one or more server 3a having the same service ID and forward the request to the specified server 3a.

(1-4-2) Reception Unit

The reception unit (request controller) 11 receives a connection request from the user terminal 2 and carries out processing in accordance with the status of the destination server 3a being the destination of the request. For example, when the destination server 3a is in the stop state, the reception unit 11 causes the proxy responding unit 14 to respond to the user terminal 2 on behalf of the destination server 3a. When the destination server 3a is in the operating state, the reception unit 11 transmits (relays) the request from the user terminal 2 to the destination server 3a.

In addition to the above processing, the reception unit 11 carries out processing of: receiving the control condition defining data from the person in charge of management and requesting the control manager 12 to set the received data therein; and transmitting a response from the destination server 3a and a proxy response from the proxy responding unit 14 to the user terminal 2.

Hereinafter, description will now be made in relation to an example of the detailed configuration of the reception unit 11, which includes a queuing unit 11a and a destination determiner 11b.

The queuing unit (holder) 11a temporarily stores therein a request (packet) received from the user terminal 2 through the interface 10d, and is achieved by, for example, the memory 10b.

The destination determiner 11b monitors the received request (packet) and recognizes the connection destination of the user terminal 2, that is, the destination address of the request. For example, the destination determiner 11b refers to the packet received therein or stored in the queuing unit 11a and obtains the destination address (e.g., an IP address).

Then the destination determiner 11b issues an inquiry request about the server status to the server manager 13 through the control manager 12. An inquiry request about the server status includes the destination address recognized by the destination determiner 11b.

In the server manager 13, the server status obtainer 13a outputs an inquiry response including the server status and the server ID or the IP address of all servers 3a that provides the same service as that provided by the server 3a having the destination address in the above-described manner. Upon receipt of the inquiry response about the server status through the control manager 12, the destination determiner 11b carries out the following control on the request from the user terminal 2 according to the following determination conditions.

(i) When the inquiry response includes server status “Running” representing the operating state:

The destination determiner 11b specifies the server 3a being in the operating state to be the destination server and forwards the request to the specified destination server 3a.

(ii) When the inquiry response does not include server status “Running” representing the operating state but does include “Stop” or “Sleep” state representing the stop state:

The destination determiner 11b specifies the server 3a being in the stop state to be the destination server 3a and causes the proxy responding unit 14 that is to be detailed below to reply to the user terminal 2, which is the transmission source of the request, on behalf of the destination server 3a.

(iii) When the inquiry response does not include server status “Running” representing the operating state or “Stop” or “Sleep” state representing the stop state but does include “Busy” representing the busy state:

In this case, all the servers 3a are in the busy state and no server 3a is in the standby (stop) state. Accordingly, the destination determiner 11b specifies the server 3a being in the busy state to be the destination server 3a and causes the proxy responding unit 14 to reply to the user terminal 2, which is the transmission source of the request, on behalf of the destination server 3a.

In all the cases (i) to (iii), when the inquiry response includes multiple servers 3a being in the same state, any of the servers 3a being in the same state can be selected to be the destination server 3a.

The destination determiner 11b determines whether the server status included in an inquiry response satisfies the above conditions in sequence of (i), (ii), and (iii).

As described above, the destination determiner 11b specifies the destination server 3a among one or more servers 3a capable of responding to the request, and carries out control on the request according to the server status of the specified destination server 3a.

The destination determiner 11b makes the determination related to the above (i) to (iii) in the same manner as the above even when no server 3a provides the same service as that provided by the server 3a having the destination address of the request. In other words, when the server status included in the inquiry response only includes the server status of the server having the destination address, the destination determiner 11b determines whether the server status is the operating state, the stop sate, or the busy state, and carries out processing according to the result of the determination.

When the above determination condition (i) is satisfied, the reception unit 11 transmits the request queued in the queuing unit 11a, as the connection request, to the destination server 3a.

When the above determination condition (ii) or (iii) is satisfied, the reception unit 11 transmits a duplicate of the request queued in the queuing unit 11a, as the proxy response request, to the proxy responding unit 14. In parallel with the proxy response, the control manager 12 and the server manager 13 carry out the startup control on the destination server 3a. After the startup of the destination server is completed and the reception unit 11 receives a notification that the startup of the destination server 3a is completed from the control manager 12, the reception unit 11 transmits the request queued in the queuing unit 11a, as the receiving response of the notification of the startup completion, to the destination server 3a.

If the destination (i.e., the destination server 3a or the proxy responding unit 14) of the request or the duplicate of the request is replaced with an address different from the destination address as a result of the determination on the above (i) through (iii), the reception unit 11 redirects the request or the duplicate of the request to the replaced new address.

As the above, while the destination server 3a is in the stop state or the busy state, the reception unit 11 causes the proxy responding unit 14 to respond to the user terminal 2 on behalf of the destination server 3a to notify the user terminal 2 of the current status of the destination server 3a. This makes it possible to abate concentration of accesses (traffic) to the destination server 3a and the network 5 caused by the user terminal 2 repetitiously retransmitting the request.

As detailed above, the server manager 13 is allowed to specify the destination server 3a that is the destination of the request from the user terminal 2 among one or more servers 3a having the same service ID and forward the request to the specified server 3a. Alternatively, the reception unit 11 (destination determiner 11b) may cause the server manager 13 to specify the destination server 3a. This means that the destination determiner 11b and the server manager 13 serve as examples collectively serve as an example of a destination controller. In this case, the destination determiner 11b makes determination of the above conditions (i) to (iii) in order to determine whether the request is forwarded or is replied with a proxy response, but does not specify the destination server 3a. Namely, when the destination server 3a is in a state corresponding to the above (i), the request is satisfactorily transmitted to the destination address of the request packet. On the contrary, when the destination server 3a is in a state corresponding to the above (ii) or (iii), the request packet is not modified and is forwarded to the proxy responding unit 14.

(1-4-3) Control Manager:

The control manager 12 manages the control condition defining data received from the manager 4; forwards an inquiry request about the server status from the reception unit 11 to the server manager 13; and forwards an inquiry response from the server manager 13 to the reception unit 11. The control manager 12 further forwards a request from the reception unit 11 to the proxy responding unit 14; forwards a proxy response from the proxy responding unit 14 to the user terminal 2 (reception unit 11); control the server status of the server 3a; and manages session data of the service that the user terminal 2 uses.

Hereinafter, an example of the detailed configuration of the control manager 12 will now be described. The control manager 12 includes, for example, a control condition manager 12a, a control determiner 12b, a session manager 12c, control condition defining data DB 12d, a control data DB 12e, and a session data DB 12f.

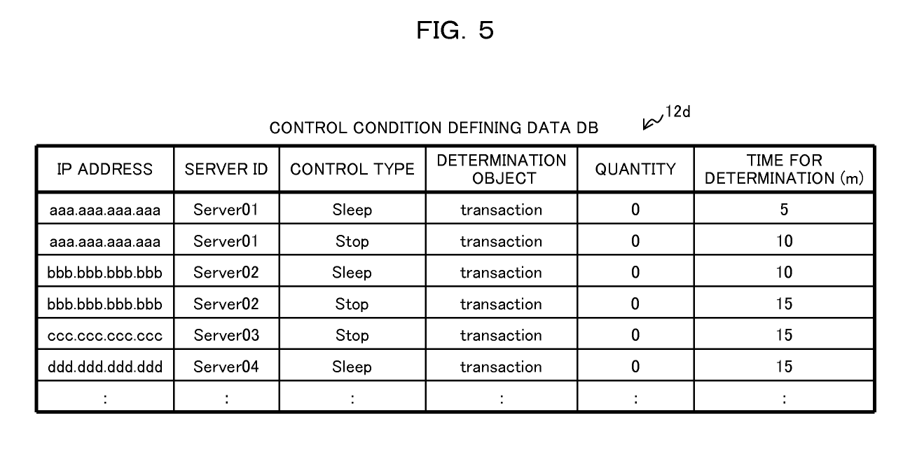

Upon receipt of the control condition defining data from the person in charge of management via the reception unit 11, the control condition manager 12a updates the control condition defining data DB 12d illustrated in FIG. 5.

The control condition defining data DB 12d is a database that defines condition to change the server statues of each service providing server 3a from the operating state to the stop state among various conditions of status control, and stores therein control condition of the data structure (status data) illustrated in FIG. 5 for each server 3a. As illustrated in FIG. 5, the control condition includes an Internet Protocol (IP) address of a server 3a, a server ID corresponding to the IP address, and a control type indicating whether the status of the server 3a is to be changed into the shut-down state or the sleep state among the stop status. In addition, the control condition includes a determination object to be used for determination whether status control is to be carried out, a quantity serving as a threshold of the determination object, and the time (m) for determination. The control condition defining data DB 12d of FIG. 5 stores therein control conditions of the servers 3a having IP addresses “aaa.aaa.aaa.aaa” through “ddd.ddd.ddd.ddd”. As an example, the server 3a having an IP address “aaa.aaa.aaa.aaa” is associated with a server ID “Server01”, a control type “Sleep”, a determination object “transaction”, a quantity “10”, and time (m) for determination “5”.

The manager 4 transmits a definition request including control condition set by the person in charge of management to the service environment control server 1. As the control condition, the person in charge of management sets at least one of the IP address and the server ID, and additionally sets the control type, a determination object, the quantity, and the time for determination. In the service environment control server 1, the control condition manager 12a receives a definition request for the control condition through the reception unit 11, and updates the control condition defining data DB 12d (by setting the received definition request in the database 12d) using the received pieces of data. Alternatively, the control condition manager 12a may collect data of the IP address or the server ID to be set in the control condition defining data DB 12d from each server 3a in advance and set the collected data in the control condition defining data DB 12d.

The control determiner 12b determines whether the status of the server 3a is to be controlled. Specifically, the control determiner 12b determines whether stop control that changes the status of the server 3a from the operating state to the stop state is to be carried out and further determines whether startup control that changes the status of the server 3a from the stop state to the operating state is to be carried out.

First of all, description will now be made in relation to a case where the control determiner 12b is to carry out the stop control.

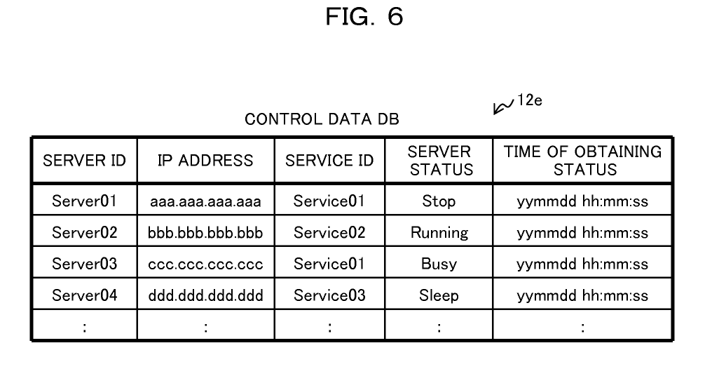

Specifically, the control determiner 12b issues an obtaining request for the server status; periodically obtains the server status from the server manager 13, and updates the control data DB 12e illustrated in FIG. 6.

The control data DB 12e is a database that manages similar data to that stored in the server status data DB 13c held by the server manager 13. In the example of FIG. 6, the control data DB 12e is different from the server status data DB 13c in the point that the item of the CPU using rate is absent but the remaining items of the control data DB 12e is the same as that of the server status data DB 13c.

The control determiner 12b updates the corresponding record in the control data DB 12e using data included in the obtaining response for the server status from the server manager 13. For example, the control manager 12 may obtain data except for the sever status, and the time of obtaining status that are to be set in the control data DB 12e in advance, and sets the obtained data in the control data DB 12e in advance. If the control manager 12 is provided with the server status data DB 13c from the server manager 13, the control manager 12 may update the entire control data DB 12e using the provided server status data DB 13c.

Upon updating the control data DB 12e, the control manager 12 compares the control condition defining data DB 12d with the control data DB 12e and determines, for each server 3a, whether the status control is to be carried out. Specifically, the control determiner 12b specifies one or more servers 3a (server IDs or IP addresses) the server status of which is the state of “Running” in the control data DB 12e, and then determines whether each specified server 3a satisfies the control condition defined in terms of the determination object, the quantity (e.g., the number of packets), and the time for determination on the control condition defining data DB 12d.

The description focuses here on a server 3a (having the server ID “Server02”) the server status of which is the state of “Running” (see FIG. 6). The control determiner 12b determines whether the server 3a in question has a transaction within the past ten minutes of zero or less and has a transaction within the past 15 minutes of zero or less (see FIG. 5).

As a result of the determination, when the transaction of the server 3a within the past ten or 15 minutes is zero or less, the control determiner 12b refers to the control type of the corresponding record on the control condition defining data DB 12d, and specifies whether the stop control to be carried out is defined for shut-down or sleep because changing the status of a server 3a for which no or less requests have issued into the stop state does not much influence on the service of the entire system. On the other hand, when the transaction of the server 3a within the past 15 minutes is not zero, the control determiner 12b determines not to carry out the status control on the server 3a.

The control determiner 12b makes the above determination on each of all the servers having a server status of “Running” by referring to the control condition. Then, upon completion of the determination on each of all the servers 3a having a server status of “Running”, the control determiner 12b generates a control request to change the status of one or more servers 3a which are determined to be subjected to status control to the respective specified control type and outputs the generated control request to the server controller 13b.

The control determiner 12b relays a request packet which has been issued from the user terminal 2 and which have been received from the reception unit 11 to the destination server 3a or the proxy responding unit 14. In relaying the request, the control determiner 12b can collect the quantity of transaction for each destination server 3a by holding the IP address of a destination server 3a and the time of relaying. This makes the control determiner 12b possible to determine whether each server 3a being the server status “Running” satisfies the control condition.

The example of FIG. 5 sets transaction to be determination object, which is not however limited to this. The determination object can be any condition that allows the control determiner 12b to recognize the using status of a server 3a through monitoring packets.

Furthermore, if the control condition of a certain server 3a is associated with multiple control types (“Sleep” or “Stop”) and the server 3a satisfies the control condition related to all the control types, the control determiner 12b can determine the control type to be applied to the server 3a in harmony with the operation.

The control determiner 12b carries out the stop control in the above manner.

The description has assumed that the control determiner 12b periodically carries out the stop control according to the control condition defining data DB 12d defined by the person in charge of management, which should by no means limited to. For example, the person in charge of management may generate a control request by referring to the control data DB 12e or server status data DB 13c and specifying the server 3a that is to undergo the status control and the control type by him/her self. In this case, the control determiner 12b forwards the control request, which is received from the person in charge of management via the manager 4, to the server manager 13.

For example, in the environmental of in-house service of a company of FIG. 1, the service providing system 3 is configured to deal with accesses from users in some extent. However, keeping the same configuration even when accesses are not concentrated so much generates surplus of the resource, which wastes the consumption power.

The control determiner 12b controls the status of the server 3a on the basis of the control condition of the server 3a set by the person in charge of management and the result of observation of the using status by users obtained by monitoring the request packets from the user terminal 2. Thereby, resource control, which has conventionally been carried out by the person or by scheduling, can be carried out at a timing considering the change in using status by users, so that the consumption power can be efficiently reduced.

The above stop control on the server 3a by the control determiner 12b is preferably applied to the service providing system 3 that provides Web service to which many users connect.

Next, description will now be made in relation to a case where the control determiner 12b is to carry out the startup control.

As the above, when the reception unit 11 determines that the destination server 3a is in the stop state, the reception unit 11 forwards a duplicate (proxy response request) of the request from the user terminal 2 to the proxy responding unit 14. When the proxy response request is to be relayed to the proxy responding unit 14, the control determiner 12b can specify the destination server 3a included in the proxy response request and that the destination server 3a is being in the stop state.

When the specified destination server 3a is in the stop state, the control determiner 12b carries out the startup control that changes the status of the destination server 3a from the stop state to the operating state. The control determiner 12b further generates a control request to change the status of the destination server 3a that is to undergo startup control to the startup state and outputs the generated control request to the server controller 13b.

Alternatively, the control determiner 12b may receive the result of the above determination related to the cases (i) to (iii) made by the destination determiner 11b to specify the destination server 3a and the server status of the destination server 3a.

Otherwise, the control determiner 12b may specify the destination server 3a and the server status of the destination server 3a by itself. For example, the control determiner 12b relays a inquiry request about the server status from the reception unit 11 and an inquiry response from the server manager 13. In relaying an inquiry response from the server manager 13 to the reception unit 11, the control determiner 12b may refer to the content of the inquiry response and thereby specify the destination server 3a and the server status of the destination server 3a in the same manner as that performed by the destination determiner 11b as described above.

As described in relation to the above case (iii), if the destination server 3a is in the busy state, every server 3a that provides the same service as that provided by the destination server 3a is in the busy state and no server 3a is in the standby (stop) state. In this case, the control determiner 12b does not carry out the startup control and waits until the destination server 3a being in the busy state comes to be in the operating state due to declining of the processing load thereon. At that time, the control determiner 12b may notify the manager 4 that the destination server 3a is in the busy state.

As described above, the control determiner 12b and server controller 13b serve as an example of the status controller 15 that carries out, when the destination server 3a of the destination of the request from the user terminal 2 is in the stop state, the startup control that changes the status of the destination server 3a from the stop state to the operating state.

The session manager 12c manages session data between the user terminal and a server 3a. For example, a request (e.g., connection request) from the user terminal 2 reaches the server 3a being in the operating state, and then the server 3a outputs a response (connection response) to the user terminal 2. If the request from the user terminal 2 is redirected to the proxy responding unit 14 by the reception unit 11, the proxy responding unit 14 outputs the response (proxy response) to the user terminal 2.

In relaying the response received via the server manager 13 to the reception unit 11, the session manager 12c refers to the response and updates the session data DB 12f illustrated in FIG. 7.

The session data DB 12f is a database that manages the connection status between the user terminal 2 and the server 3a for each session that the server 3a provides, and specifically stores therein session records having the data structure illustrated in FIG. 7 for each session. As illustrated in FIG. 7, the session data includes a session ID that identifies the session, a service ID of the service that the user terminal 2 is to be used, a user ID that identifies the user terminal 2, and connection status between the user terminal 2 and the server 3a. The session data DB 12f of FIG. 7 stores therein session data having session IDs “Session01” to “Session 04”. As an example, the session ID “Session01” is associated with the service ID “Service01”, the user ID “User01”, and the connection status “Redirected”.

The session manager 12c refers to the response from the server 3a or the proxy responding unit 14 to the user terminal 2 and obtains and sets the session ID, the service ID, and the user ID included in the response in the session data DB 12f. The session manager 12c sets, when the response is transmitted from the server 3a, “Connected” in the connection status of the corresponding record of the session data DB 12f; while sets, when the response is transmitted from the proxy responding unit 14, “Redirected” in the connection status.

As the above, the session data DB 12f associates “Connected” with a state where a connection between the user terminal 2 and the server 3a has been established and associates “Redirected” with a state where the server 3a is in the stop state and the request does not reach the server 3a for each session.

After the destination server 3a being in the stop state is started up by the status controller 15, the session manager 12c refers to the response from the destination server 3a to the user terminal 2. The session manager 12c manages the control data DB 12e and session data DB 12f in association with each other using common server IDs or the IP addresses.

Upon detecting the change in the server status of the destination server 3a into “Running” in the control data DB 12e, the session manager 12c changes the connection status of the relevant record in the session data DB 12f from “Redirected” to “Connected”.

Even when the destination server 3a is temporarily incapable of transmitting a response to the user terminal 2, the above management by the session manager 12c makes the user terminal 2 possible to maintain the session with the transmission source of the proxy response. After the destination server is started up and comes into the operating state, the session manager 12c switches the session easily on the basis of the response from the destination server 3a to the user terminal 2.

(1-4-4) Proxy Responding Unit:

Upon receipt of a proxy response request, i.e., a duplicate of the request form the user terminal 2, from the reception unit 11 via the control manager 12, the proxy responding unit 14 issues a proxy response to the user terminal 2, which has issued the request, on behalf of the destination server 3a. An example of the proxy response includes a message of “please wait for a while because the server is starting up” that refrains the user from retransmitting the request. For this purpose, the proxy response may include a Uniform Resource Identifier (URI) of the wait screen that displays the above message.

The proxy responding unit 14 exemplarily includes a proxy responding data DB 14a.

Upon receipt of a proxy response request, the proxy responding unit 14 obtains a URI that is to be included in a proxy response from the proxy responding data DB 14a of FIG. 8 on the basis of the destination address of the request or the IP address of the destination server 3a, and then issues the proxy response including the obtained URI.

The proxy responding data DB 14a is a database that manages messages (e.g., the URI of a wait screen) to be transmitted to the user terminal 2 for each service providing server 3a, and specifically stores therein proxy response data having the data configuration illustrated in FIG. 8 for each server 3a. As illustrated in FIG. 8, the proxy response data includes a server ID of the server 3a, an IP address, a service ID that the server 3a provides, and a content URI to be included in the proxy response. The proxy responding data DB 14a illustrated in FIG. 8 stores therein proxy response data of IP addresses “aaa.aaa.aaa.aaa” through “ddd.ddd.ddd.ddd”. As an example, the IP address “aaa.aaa.aaa.aaa” is associated with the server ID “Server01”, a service ID “Service01”, a response content URI “http://Service01/Answer”.

The proxy responding unit 14 preferably collects a server ID, an IP address, and a service ID that are to be set in the proxy responding data DB 14a from each server 3a, and sets these pieces of the obtained data in the proxy responding data DB 14a beforehand. The content URI of proxy response data is set by, for example, the person in charge of management via the manager 4. The proxy response content URI may represent the resource of any of the service environment control server 1, the server 3a, and the manager 4.

(1-5) Example of Operation:

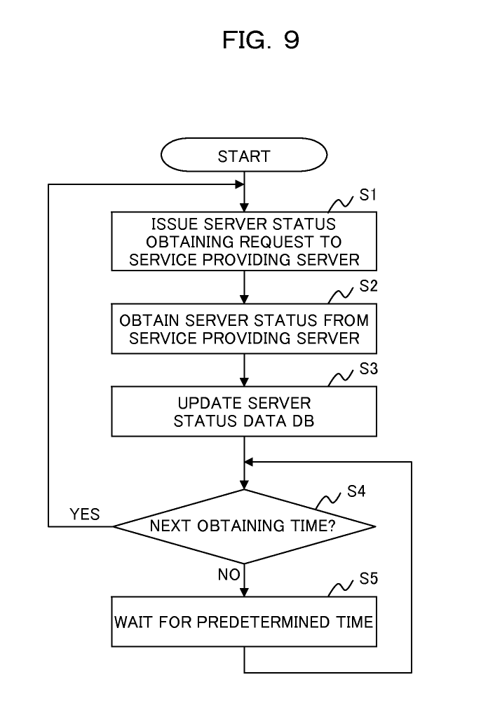

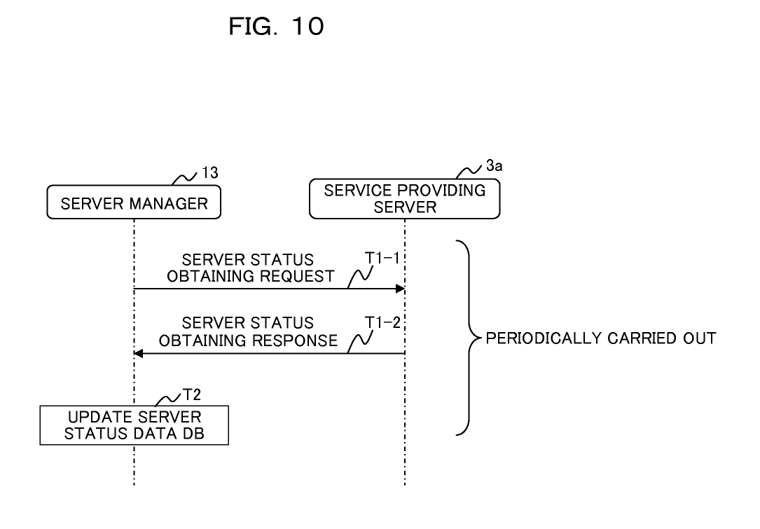

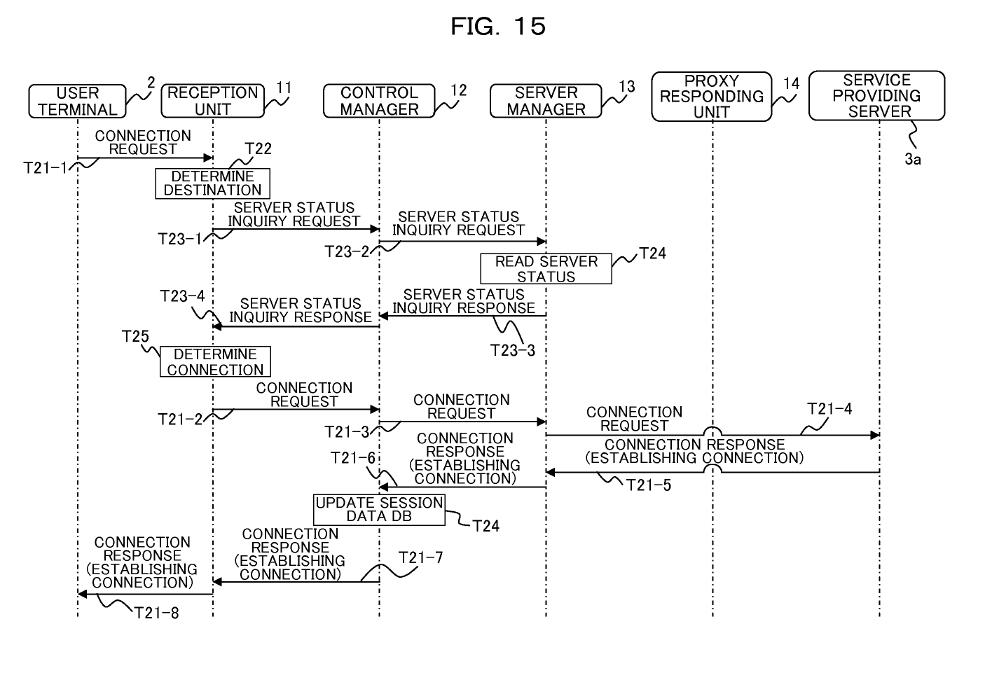

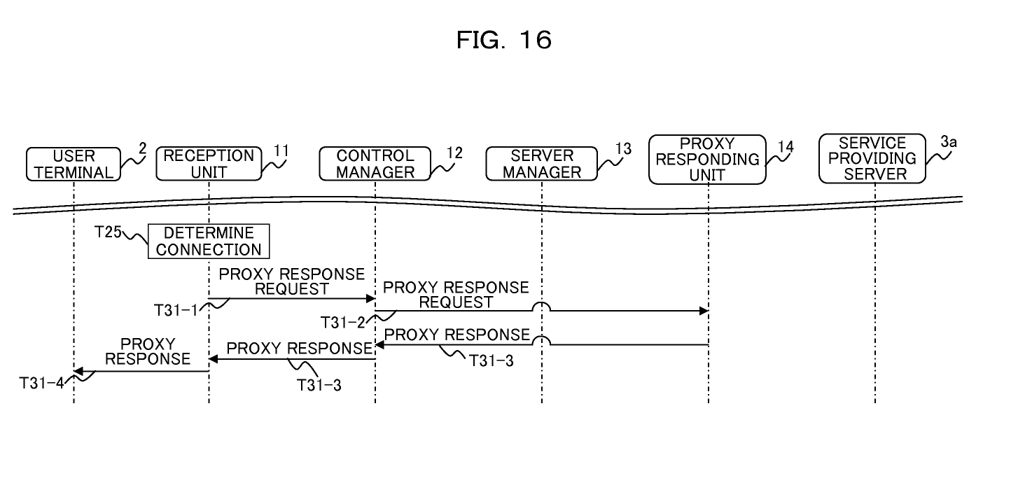

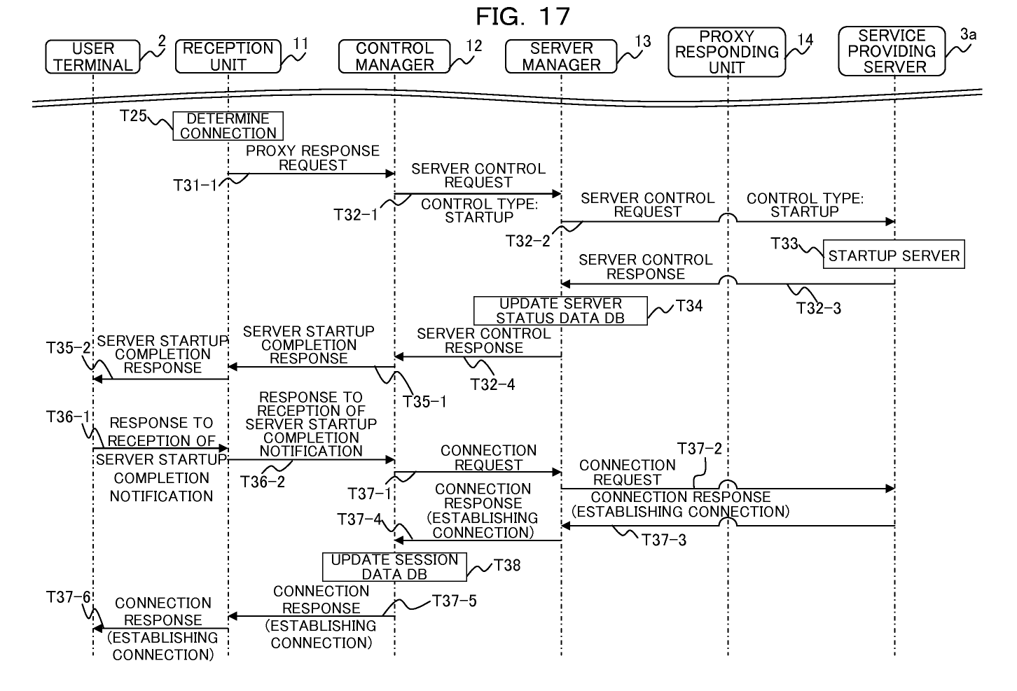

Next, description will now be made in relation to operation performed by the service environment control server 1 having the above configuration with reference to FIGS. 9-17. FIGS. 9, 11, 13, and 14 are flow diagrams each illustrating a succession of procedural steps of the service environment control server 1 of the first embodiment; and FIGS. 10, 12, and 15-17 are sequence diagrams each illustrating an example of a succession of procedural steps of the service environment control server 1 of the first embodiment. The procedural steps to step T25 in FIGS. 16 and 17 are the same as that of FIG. 15, so part of steps in FIGS. 16 and 17 are omitted here.

(1-5-1) An Example of Obtaining Server Status by the Server Manager:

First of all, description will now be given in relation to obtaining server status by the server manager 13 with reference to FIGS. 9 and 10.

As illustrated in FIG. 9, the server manager 13 issues a server status obtaining request to the server 3a (step S1, process T1-1 in FIG. 10). Upon receipt of the server status obtaining request from the control manager 12, the server manager 13 issues the server status obtaining request to the server 3a. Upon receipt of the server status obtaining request, the server 3a transmits server status obtaining response including the server status to the server manager 13 (step S2, process T1-2 in FIG. 10).

Upon receipt of the server status obtaining response, the server manager 13 updates the server status data DB 13c of FIG. 4 using the server status included in the obtained server status obtaining response (step S3, process T2 in FIG. 10).

Next, the control manager 12 determines that the current time reaches the next obtaining time of the server status (step S4). If the current time does not reach the next obtaining time yet (No route in step S4), the control manager 12 waits for a predetermined time (step S5) and then returns the procedure to step S4.

On the other hand, if the current time reaches the next obtaining time (Yes route in step S4), the control manager 12 returns the procedure to step S1, in which the control manager 12 issues another server status obtaining request to the server manager 13.

As the above, the server manager 13 obtains the server status.

(1-5-2) Example of Setting the Control Condition Defining Data and the Stop Control of the Service Providing Server in the Service Environment Control Server:

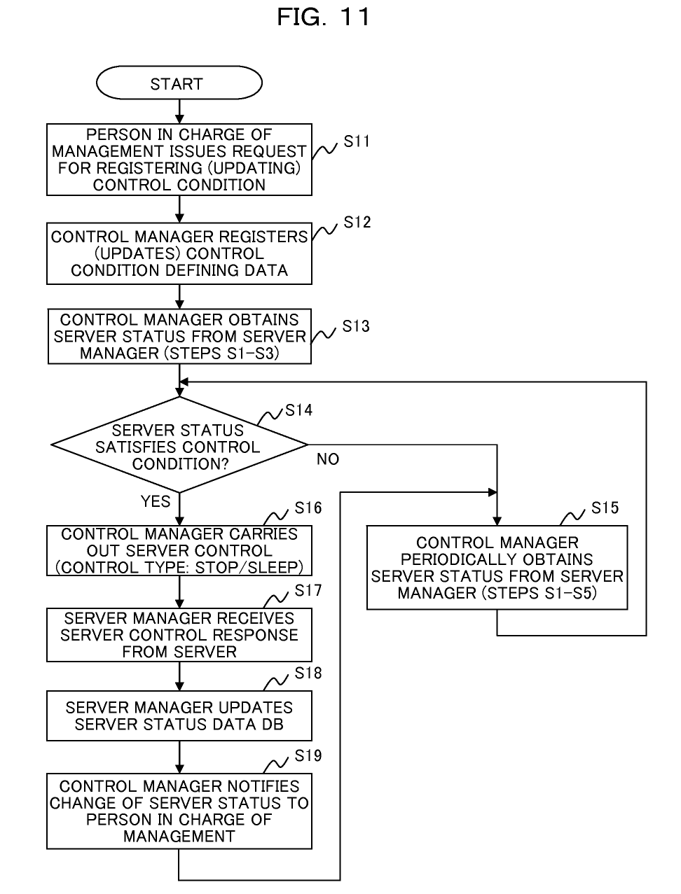

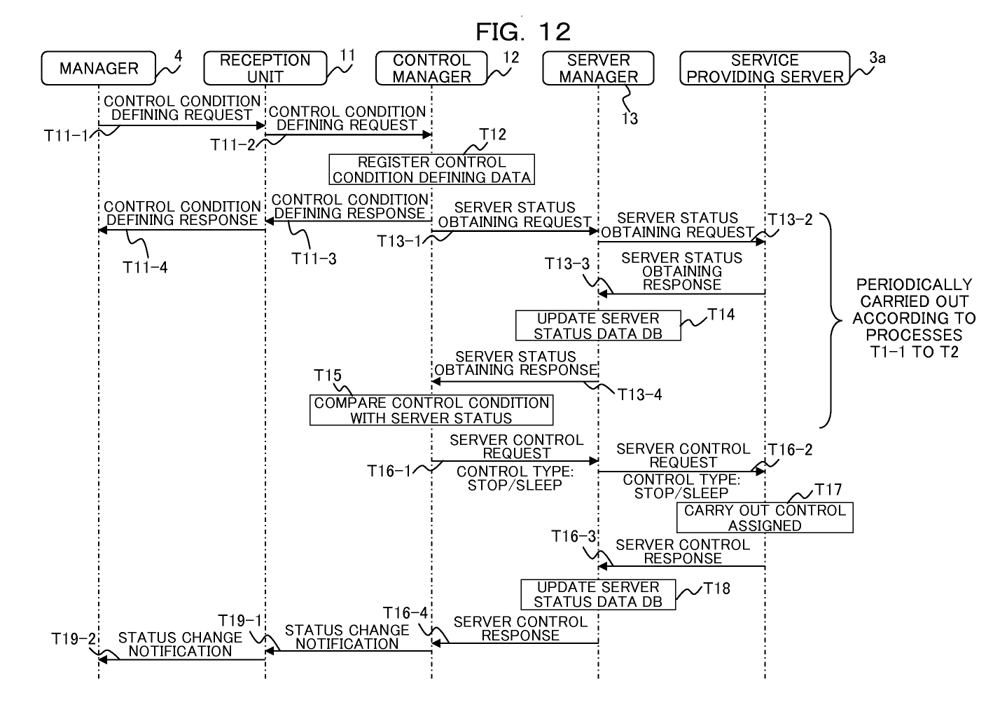

Next, description will now be made in relation to an example of setting the control condition defining data and the stop control of the service providing server 3a in the service environment control server 1 with reference to FIGS. 11 and 12.

First of all, as illustrated in FIG. 11, the person in charge of management sets the control condition using the manager 4, which then issues a control condition defining request to the control manager 12 (step S11). The issued control condition defining request is received by the control manager 12 through the reception unit 11 (processes T11-1 and T11-2 of FIG. 12).

Next, the control manager 12 registers (updates) the control condition defining data DB 12d using the control condition included in the received control condition defining request (step S12, process T12 in FIG. 12). After that, the control manager 12 transmits a control condition defining response including data whether the control condition is successfully completed, and the control condition defining request is received by the manager 4 via the reception unit (processes T11-3 and T11-4 of FIG. 12).

The control manager 12 further issues a server status obtaining request to the server manager 13 (process T13-1 of FIG. 12). The server manager 13 carries out the procedure of steps S1-S3 of FIG. 9 and thereby updates the server status data DB 13c (steps S13, processes T13-2, T13-3, and T14 of FIG. 12). After the server status data DB 13c is updated, the server manager 13 issues a server status obtaining response including the obtained server status to the control manager 12 (process T13-4 of FIG. 12).

Next, the control manager 12 determines whether the server status included in the server status obtaining response obtained from the control manager 13 satisfies the control condition defined in the control condition defining data DB 12d (step S14, process T15 of FIG. 12). If the server status does not satisfy the control condition (No route in step S14), the control manager 12 and the server manager 13 carry out the procedure of the steps S1-S5 of FIG. 9 (step S15) and move the procedure to step S14. Namely, the processes T13-1 to 13-4, T14, and T15 are carried out. Here, the step S15 is periodically carried out.

On the other hand, if the server status satisfies the control condition in step S14 (Yes route in step S14), the control manager 12 issues a server control request including, as the control type, “Stop” or “Sleep” to the server 3a (step S16). The server control request is received by the server 3a via the server manager 13 (processes T16-1 and 16-2 of FIG. 12).

Then the server 3a carries out the stop process according to the control type included in the received control request (process T17 of FIG. 12) and issues the result of the stop process, as a server control response, to the control manage 12. The server control request is received by the control manager 12 via the server manager 13 (step S17, process T16-3 and T16-4 of FIG. 12). At that time, The server manager 13, which has received the server control response, updates the server status data DB 13c using the result of the stop process performed by the server 3a (step S18, process T18 of FIG. 12).

The control manager 12, which has received the server control response, issues a status changed notification including the server status of the server 3a whose status has been changed and the IP address or the server ID on the basis of the result of the stop process by the server 3a to the manager 4 (step S19). The status changed notification is received by the manager 4 via the reception unit 11 (processes T19-1 and T19-2 of FIG. 12).

The control condition defining data is set and the stop control of the service providing server in the service environment control server 1 is performed in the above manner.

(1-5-3) Processing Responsive to a Connection Request from a User Terminal to the Service Environment Control Server and Example of a Connection Process Between a User Terminal and a Service Providing Server:

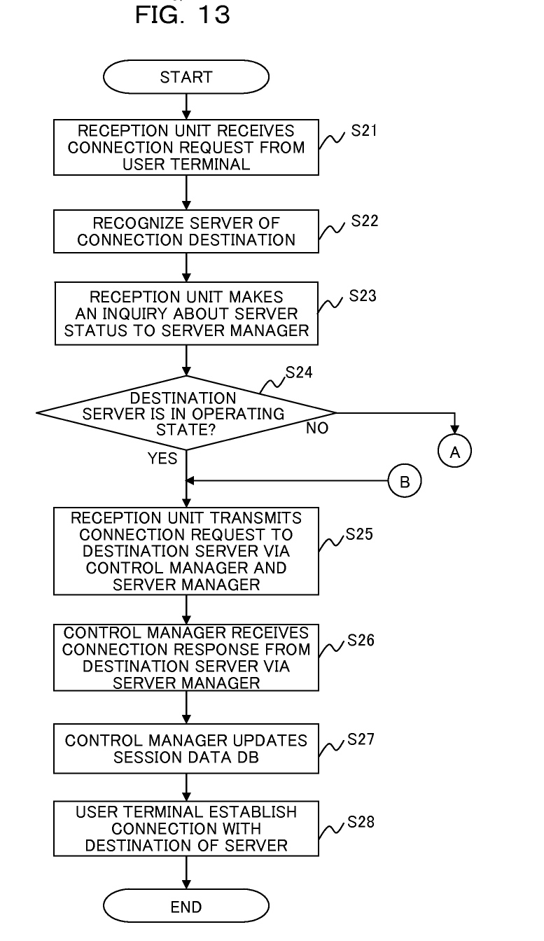

Next, description will now be made in relation to processing in the service environment control server 1 in response to a connection request from the user terminal 2 and an example of a connection processing between the user terminal 2 and the service providing server 3a with reference to FIGS. 13-17.

As illustrated in FIG. 13, to begin with, the reception unit 11 receives a connection request from the user terminal 2 (step S21, process T21-1 in FIG. 15). The connection request is stored in the queuing unit 11a of the reception unit 11. Then, the reception unit 11 recognizes the server to be the connection destination of the received connection request, for example, the destination address (step S22, process T22 in FIG. 15).

Next, the reception unit 11 issues a server status inquiry request containing the recognized destination address to the server manager 13 (step S23). The server status inquiry request is received in the server manager 13 via the control manager 12 (processes T23-1 and T23-2 in FIG. 15). The server manager 13 recognizes all the servers 3a that provide the same service that the server having the destination address contained in the received server status inquiry request by referring to the service IDs in the server status data DB 13c, and transmits the server status obtaining response containing the result of the recognition to the reception unit 11 (step S23). The server status obtaining response is received by the reception unit 11 via the control manager 12 (processes T23-3 and T23-4 in FIG. 15).

On the basis of the received server status obtaining response, the reception unit 11 specifies the destination server 3a and the server status of the destination server 3a in accordance with the above determination conditions (i) to (iii). Then the reception unit 11 determines whether the server status of the destination server 3a is the operating state (step S24, process T25 in FIG. 15).

If the server status of the destination server 3a is the operating state (Yes route in step S24), the reception unit 11 transmits the connection request stored in the queuing unit 11a to the destination server 3a (step S25). The connection request is received in the destination server 3a via the control manager 12 and the server manager 13 (processes T21-2 to T21-4 of FIG. 15).

The destination server 3a carries out a connection process according to the received connection request and transmits a connection response containing the result of determining whether the connection can be established to the control manager 12 (step S26). The connection response is received in the control manager 12 via the server manager 13 (processes T21-5 and T21-6 in FIG. 15).

The control manger 12 refers to the received connection response and updates the connection status in the session data DB 12f on the basis of the result of the determination whether the connection can be established (step S27, process T24 in FIG. 15). Then, the control manager 12 forwards the connection response to the user terminal 2. The connection response is received in the user terminal 2 via the reception unit 11 (processes T21-7 and T21-8 of FIG. 15).

The user terminal 2 establishes connection to the destined server 3a (step S28) on the basis of the result of the determination whether the connection can be established contained in the received connection response and information such as the Uniform. Resource Locator (URL) of the log-in screen (if the determination resulted in that the connection can be established).

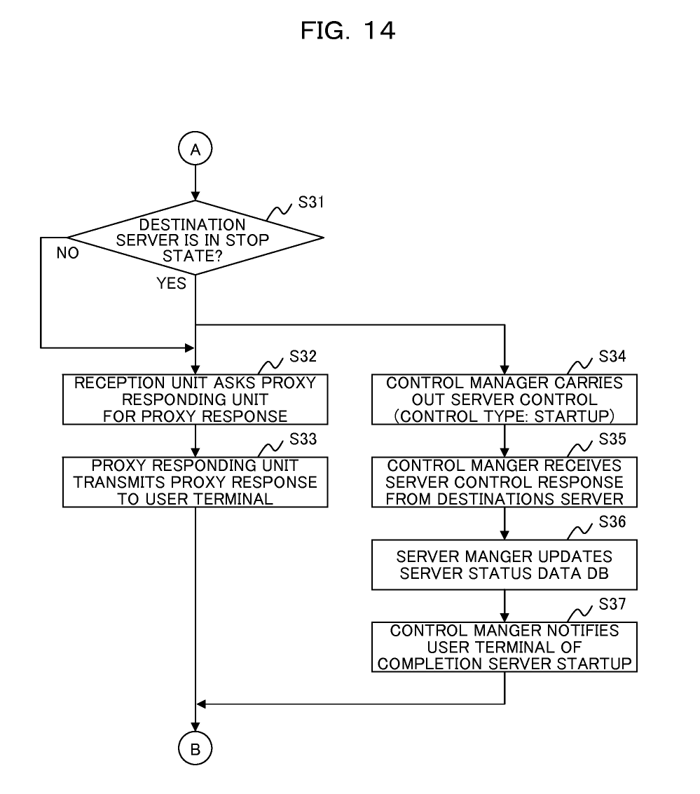

In contrast, if the destination server 3a is not in the operating state in step S24 (No route in step S24), the procedure moves to step S31 in FIG. 14.

As illustrated in FIG. 14, determination as to whether the destination server 3a is in the stop state is made in step S31.

If the destination server is in the stop state (Yes route in step S31), the procedure moves to steps S32 and S34, which are carried out in parallel with each other.

In step S32, the reception unit 11 transmits, to the proxy responding unit 14, a proxy response request to the connection request issued from the user terminal 2. The proxy response request is received in the proxy responding unit 14 via the control manager 12 (processes T31-1 and T31-2 in FIG. 16). On the basis of the proxy response request, the proxy responding unit 14 transmits a proxy response to the user terminal (step S33). The proxy response is received in the user terminal 2 via the control manager 12 and the reception unit 11 (processes T31-3 and T31-4 in FIG. 16). Accessing the URI contained in the received proxy response, the user terminal 2 displays thereon a proxy responding screen. Here, when step S37, which is carried out in parallel to steps S33 and S34, is completed, the procedure moves to step S25.

Meanwhile, in step S34, the control manager 12 refers to the proxy response request (see process T31-2 in FIG. 16) that is to be relayed to the proxy responding unit 14, and thereby specifies the destination server 3a and that the destination server 3a is in the stop state. If the destination server 3a is specified to be in the stop state, the control manager 12 issues a server control request containing the control type of “startup” to the destination server 3a. The server control request is received in the destination server 3a via the server manager 13 (processes T32-1 and T32-2 in FIG. 17).

The destination server 3a carries out the startup process according to the control type contained in the received server control request (process T33 in FIG. 17) and issues the result of the startup process to the control manager 12. The server control response is received in the control manager 12 via the server manager 13 (step S35, processes T32-3 and T32-4 in FIG. 17). Upon receipt of the server control response, the sever manager 13 updates the server status DB 13c on the basis of the result of the startup process carried out by the destination server 3a (step S36, process T34 in FIG. 17).

Upon receipt of the server control response, the control manger 12 notifies the user terminal 2 of a server startup completion notification that indicates that the startup of the destination server 3a is completed (i.e., that the destination server 3a has been ready for connection) on the basis of the result of the startup process in the destination server (step S37). The server startup completion notification is received in the user terminal 2 via the reception unit 11 (processes T35-1 and T35-2 in FIG. 17).

The user terminal 2 issues a response to reception of server startup completion notification to the server startup completion notification and then the procedure moves to step S25 in FIG. 13.

Specifically, upon receipt of the response to reception of server startup completion notification (process T36-1 in FIG. 17), the reception unit 11 attaches the connection request stored in the queuing unit 11a to the response and transmits the response containing the connection request to the control manager 12 (process T36-2 in FIG. 17).

The control manager 12 transmits the received connection request to the destination server 3a. The connection request is received in the destination server 3a via the server manager 13 (processes T37-1 and T37-2 in FIG. 17).

The destination server 3a carries out a connection process according to the received connection request and then transmits a connection response containing the result of determination made on the connection to the control manager (step S26). The connection response is received in the control manager 12 via the server manager 13 (processes T37-3 and T37-4 in FIG. 17).

The control manager 12 refers to the connection response and updates the connection status in the session data DB 12f on the basis of the result of determination made on the connection (step S27, process T38 in FIG. 17). The connection response is then forwarded from the control manager 12, and is received in the user terminal 2 via the reception unit 11 (processes T37-5 and T37-6 in FIG. 17).

The user terminal 2 establishes connection to the destination server 3a (step S28) on the basis of the result of the determination whether the connection can be established contained in the received connection response and information such as the URL of the log-in screen (if the determination resulted in that the connection can be established).

In the service environment control server 1, the processing responsive to a connection request from the user terminal 2 and example of establishing connection between the user terminal 2 and a service providing server 3a are carried out in the above manner.

The control manager 12 may specify the destination server 3a and the server status of the destination server by itself upon receipt of a server status inquiry response from the server manager 13 (see process T23-3 in FIG. 15). In this case, the process of step S34 of FIG. 14 (process T32-1 in FIG. 17) and beyond may be carried out when the step S23 in FIG. 13 (process T23-3 in FIG. 15) is carried out.

(2) Others:

A preferred embodiment of the present invention is detailed as the above, but the present invention should by no means be limited to the foregoing embodiment. Various changes and modifications can be suggested without departing the gist of the present invention.

In the above first embodiment, transmission of various data pieces containing requests and response among the blocks of the reception unit 11, the control manager 12, the server manager 13, and the proxy responding unit 14 may be appropriately omitted. For example, if the databases are stored in the storing unit 10c shared by the blocks, the data transmission can be replaced with referring to the databases stored in the storing unit 10c by the blocks and therefore can be omitted.

The entire or part of the function of the service environment control server 1 may be achieved by a computer (e.g., a CPU, an information processing unit, various terminals) executing programs.

The program may be in the form of being stored in a computer-readable recording medium such as a flexible di sk, a CD (e.g., CD-ROM, CD-R, and CD-RW), a DVD (e.g., DVD-ROM, DVD-RAM, DVD-R, DVD-RW, DVD+R, and DVD+RW), and a Blu-ray disk, and is exemplified by the recording medium 10h illustrated in FIG. 2. The computer reads the program from the recording medium and stores the program into an internal or external memory for future use.

Here, a computer is a concept of a combination of hardware and an OS and means hardware which operates under control of the OS. Otherwise, if an application program operates hardware independently of an OS, the hardware corresponds to the computer. Hardware includes at least a microprocessor such as a CPU and means to read a computer program recorded in a recording medium. The application program includes a program code to causes a computer as defined the above to achieve the functions as the service environment control server 1. Part of the functions may be achieved by the OS, not by the application program.

The technique disclosed herein avoid decline in system performance caused when a processing device is in a state (stop state) of temporarily having a difficulty in responding to a request from a terminal device.

All examples and conditional language provided herein are intended for pedagogical purposes to aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiment (s) of the present invention have been described in detail, it should be understood that the various changes, substitutions, and alterations could be made hereto without departing from the spirit and scope of the invention.

What is claimed is:

1. A controller disposed between a terminal device and one or more processing devices that carry out processing in response to a request from the terminal device, the controller controlling the processing devices and comprising:
a processor that:
when a destination processing device that is to respond to the request from the terminal device among the processing devices is in a stop state,
carries out startup control to change status of the destination processing device from the stop state to an operating state, and causes a proxy responding unit that responds to the terminal device on behalf of the one or more destination processing devices to respond to the terminal device; and
after the status of the destination processing device is changed to the operating state,
transmits the request from the terminal device to the destination processing device.

2. The controller according to claim 1, wherein the processor further carries out stop control to change status of one or more of the processing devices satisfying a predetermined condition from the operating state to the stop state in response to requests issued to the processing devices within a predetermined period.

3. The controller according to claim 2, wherein the processor carries out the stop control on one or more of the processing devices each for which requests not more than a threshold are issued within the predetermined period.

4. The controller according to claim 1, wherein the processor further obtains status of each of the processing devices and specifies the destination processing device based on the obtained status among one or more of the processing devices providing a service the same as a service provided by one of the processing devices corresponding to a destination address contained in the request from the terminal device.

5. The controller according to claim 1, further comprising a holder that stores therein the request from the terminal device, wherein, the processor:
when the destination processing device is in the stop state,
forwards a duplicate of the request stored in the holder to the proxy responding unit; and
after the status of the destination processing device is changed to the operating state,
transmitting the request stored in the holder from the terminal device to the destination processing device.

6. The controller according to claim 1, wherein the processor further include a function of the proxy responding unit that responds to the terminal device that issues the request according to the destination processing device on behalf of the destination processing device.

7. A method for controlling performed by a controller disposed between a terminal device and one or more processing devices that carry out processing in response to a request from the terminal device, the controller controlling the processing devices, the method comprising:
when a destination processing device that is to respond to the request from the terminal device among the processing devices is in a stop state,
carrying out startup control to change status of the destination processing device from the stop state to an operating state, and responding to the terminal device on behalf of the destination processing device; and
after the status of the destination processing device is changed to the operating state,
transmitting the request from the terminal device to the destination processing device.

8. The method according to claim 7, wherein further comprising carrying out stop control to change status of one or more of the processing devices satisfying a predetermined condition from the operating state to the stop state in response to requests issued to the processing devices within a predetermined period.

9. The method according to claim 8, wherein the stop control is carried out on one or more of the processing device each for which requests not more than a threshold are issued within the predetermined period.

10. The method according to claim 7, further comprising:
obtaining status of each of the processing devices; and
specifying the destination processing device based on the obtained status among one or more of the processing devices providing a service the same as a service provided by one of the processing devices corresponding to a destination address contained in the request from the terminal device.

11. The method according to claim 7, wherein the responding to the terminal device on behalf of the destination processing device comprises:
when the destination processing device is in the stop state,
responding to the terminal device with the request stored in a holder that stores therein the request from the terminal device on behalf of the destination processing device; and
after the status of the destination processing device is changed to the operating state,
transmitting the request stored in the holder from the terminal device to the destination processing device.

12. A computer-readable recording medium having stored therein a control program for causing a computer disposed between a terminal device and one or more processing devices that carry out processing in response to a request from the terminal device to execute a controlling process for the processing devices, the process comprising:
when a destination processing device that is to respond to the request from the terminal device among the processing devices is in a stop state,
carrying out startup control to change status of the destination processing device from the stop state to an operating state, and responding to the terminal device on behalf of the destination processing device; and
after the status of the destination processing device is changed to the operating state,
transmitting the request from the terminal device to the destination processing device.

13. The computer-readable recording medium according to claim 12, wherein the process further comprises carrying out stop control to change status of one or more of the processing devices satisfying a predetermined condition from the operating state to the stop state in response to the request issued to the processing devices within a predetermined period.

14. The computer-readable recording medium according to claim 13, wherein the process further comprises carrying out the stop control on one or more of the processing device each for which requests not more than a threshold are issued within the predetermined period.

15. The computer-readable recording medium according to claim 12, wherein the process further comprises:
obtaining status of each of the processing devices; and
specifying the destination processing device based on the obtained status among one or more of the processing devices providing a service the same as a service provided by one of the processing devices corresponding to a destination address contained in the request from the terminal device.

16. The computer-readable recording medium according to claim 12, wherein the process further comprises:
when the destination processing device is in the stop state,
responding to the terminal device with the request stored in a holder that stores therein the request from the terminal device on behalf of the destination processing device; and
after the status of the destination processing device is changed to the operating state,
transmitting the request stored in the holder from the terminal device to the destination processing device.
